(19) United States
(12) Patent Application Publication
(10) Pub. No.: US 2016/0000118 A1
(43) Pub. Date: Jan. 7, 2016

(54) TOTAL MIXED RATIONS FOR RUMINANTS INCLUDING CEPHALARIA JOPPENSIS

(71) Applicants: Joshua Miron, Givat Shmuel (IL); Uri Kushnir, Givataim (IL)

(72) Inventors: Joshua Miron, Givat Shmuel (IL); Uri Kushnir, Givataim (IL)

(21) Appl. No.: 14/850,079

(22) Filed: Sep. 10, 2015

Related U.S. Application Data
(63) Continuation-in-part of application No. 13/695,260, filed on Oct. 29, 2012, now abandoned.
(60) Provisional application No. 61/329,122, filed on Apr. 29, 2010.

(51) Int. Cl. A23K 1/14; A23K 1/175; A23K 1/16; A23K 1/18; A23K 1/00

(52) U.S. Cl. CPC A23K 1/14; A23K 1/1813; A23K 1/007; A23K 1/146; A23K 1/1603; A23K 1/1631; A23K 1/175

(57) ABSTRACT

A novel feed source for ruminants is prepared from the annual herbaceaous plant Cephalaria joppensis. The plant can be raised in the field, harvested and treated as hay or ensiled. Feed preparations such as total mixed rations (TMRs) including the harvested plant can form a substitute to roughage sources of the prior art without degrading the quality of the feed in terms of animal welfare and milk quality and quantity.

### CROSS-REFERENCE TO RELATED PATENT APPLICATIONS

This application is a continuation-in-part patent application of U.S. patent application Ser. No. 13/695,260, which is the U.S. national stage patent application of International Application No. PCT/IB2011/051873, entitled “Novel Ruminant Feed,” which was filed on Apr. 28, 2011, and which claims priority to and the benefit of U.S. Provisional Patent Application No. 61/329,122, entitled “Novel Use of the Wild Species Cephalaria Joppensis as Forage for Feeding Ruminants,” filed on Apr. 29, 2010, the entire contents of each of which are incorporated herein by reference.

### FIELD

The present teachings relate to a new food source for ruminants. More particularly, the present teachings relate to a use of the wild herbaceous species Cephalaria joppensis in total mixed rations (TMRs) for ruminants.

### BACKGROUND

Ruminants have a complex digestion mechanism which characterize their specific needs as regards to the uptake and exploitation of food. Since many species and varieties of ruminants are domesticated, their specific traits as such and especially feeding reflect on the economy of farming and even on world economy.

Feeding productive ruminants is the largest cost associated with milk and meat production, typically accounting for 60%-70% of the total production costs. The food quality has a large influence on the milk and meat production. Ruminants require energy, protein, vitamins, minerals, fiber, and water. Energy (calories) is usually the most limiting nutrient, whereas protein is the most expensive. Deficiencies, excesses, and imbalances of vitamins and minerals can limit animal performance and lead to various health problems. Fiber is necessary to maintain a healthy rumen environment and prevent digestive upsets and is served as an important energy source for the animal. Hay is one of the primary sources of roughages for ruminants and it is used during the winter or non-grazing season in cold places. Hay varies in quality and the only way to know its nutritional content is to have the hay analyzed by a forage testing laboratory. Hay tends to be a moderate source of protein and energy for sheep and goats. Legume hays such as alfalfa, clover, and vetch tend to be higher in protein, vitamins and minerals, than grass hays (like oat or wheat). The energy as well as protein content of hay depends upon the phenological stage of the forage crop at the time of harvesting. Proper curing and storage is also necessary to maintain nutritional quality of hay.

Silage made from wet forage or grain crops is widely used to feed productive ruminants because high-producing animals can often consume willingly high levels of moisture silage to meet their nutritional needs. Silages are also easily mixed with other ration ingredients to produce palatable total mixed rations for productive ruminants. Ensiling is a fermentation process involving microorganisms and need to be attended properly. Several systems and methods for producing silage are known in the art, for example, see U.S. Patent Application No. 2010/0278968 A1.

In the science of animal husbandry there are many techniques used to evaluate the response of the animals to food, food components and quantities thereof, as regards health parameters, meat and milk production, and fecundity. In “Effects of feeding cows in early lactation with soy hulls as partial forage replacement on heat production, retained energy and performance,” by J. Miron et al. in Animal Feed Science and Technology 155 (2010) 9-17, several such aspects of as digestibility, milk yield and composition. In “Preservation of total mixed rations for dairy cows in bales wrapped with polyethylene stretch film—A commercial scale experiment,” by Z. G. Weinberg et al., Animal Feed Science and Technology 164 (2011) 125-129, details of ensiling of feed for ruminants are discussed, with a special attention to plastic bails.

### SUMMARY

It has now been discovered that the harvested broad leaf species Cephalaria joppensis can be used as a feed crop for ruminants such as dairy cows, sheep and goats, and growing heifers, bulls, lambs and kids, where the nutritive value of Cephalaria joppensis can be similar to that of wheat roughage. That is, harvested Cephalaria joppensis and one or more additional feed components can form a total mixed ration for feeding ruminants, where the harvested Cephalaria joppensis can be or can form a part of the total dietary roughage in the total mixed ration.

More specifically, in various embodiments, a total mixed ration (TMR) can include harvested Cephalaria joppensis and an additional feed component. For heifers and/or dry cows and/or dry sheep, about 5% by weight to about 85% by weight of the dry matter of the TMR can include harvested Cephalaria joppensis. For lactating ruminants such as lactating cows and/or lactating ewes and/or lactating goats, about 5% by weight to about 50% by weight of the dry matter of the TMR can include harvested Cephalaria joppensis. For lambs, kids or bulls, about 5% by weight to about 30% by weight of the dry matter of the TMR can include harvested Cephalaria joppensis.

The harvested Cephalaria joppensis can include at least one of ensiled Cephalaria joppensis and dried Cephalaria joppensis. Dried Cephalaria joppensis can be referred to as wilted Cephalaria joppensis or Cephalaria joppensis hay. Ensiled Cephalaria joppensis can be referred to as Cephalaria joppensis silage.

In some embodiments, the additional feed component includes at least one of a grain, a mineral, a vitamin, and a protein source.

In certain embodiments, a TMR of the present teachings can include Cephalaria joppensis as the sole source of roughage such as dietary roughage (or forage) in the TMR. However, in particular embodiments, other sources of roughage or forage can be combined with Cephalaria joppensis to make up the total amount of roughage in the TMR. Other sources of roughage can include wheat silage, maize silage, sorghum silage, legume silage, grass silage, wheat hay, maize hay, sorghum hay, grass hay, and legume hay. Legume silage can include one or more of alfalfa silage, clover silage, and vetch silage. Legume hay can include one or more of alfalfa hay, clover hay, and vetch hay.

The foregoing as well as other features and advantages of the present teachings will be more fully understood from the following description, examples, and claims.

### DETAILED DESCRIPTION

The wild annual broad leaf (Dicotyledonaceaous) species Cephalaria joppensis (hereinafter “CJ”) (see U.S. Department of Agriculture, GRIN taxonomy of plants) grows in many of the Mediterranean districts of Israel and other Eastern and central Mediterranean countries. It is modest in its requirements for water, rain fed under Mediterranean climate condition, and also in adjacent semiarid districts. Although the Mediterranean climate is typified by an arid summer, CJ flourishes into the summer and also flowers at the warm, dry season, completing the growth cycle well into the end of the dry season. CJ can be grown wherever wheat is grown.

Phenological aspects of the herbaceous CJ and their practical implications. To accommodate the CJ to provide inputs for satisfying animal husbandry needs, several varieties were selected from wild populations, specifically in order to provide a prolonged harvesting period. The phenological aspects of the wild type are such that while dry matter accumulation in spring progresses, a by-product of the aging starts to accumulate, namely lignification process progresses, concomitantly eventually increasing the percentage of lignified tissue in the crop. Optimizing of harvesting time requires to find the time in which dry mass versus lignification is at practical peak. Another limit to harvesting is the fruiting. The fact is that the fruit of CJ are bitter and deter animals from feeding upon the herb, therefore harvest must be accomplished before fruiting. To accommodate the crop to commercial use, varieties are being developed with various degrees of earliness to mature and flower, for providing a prolonged harvesting period.

In accordance with the present teachings, several feed preparations for ruminants are made possible using the harvested canopy of the CJ, typically by applying customary preparation methods, for obtaining a valuable addition to the list of existing dietary inputs for ruminants. Domesticated CJ constitutes an alternative dicotyledonaceous (broad leaf) crop in crop rotation of the agricultural field crop system.

Feed preparations using CJ can include the following.

1. Hay (dried or wilted preparations). The crop is harvested, left in the field to dry in the sun, usually for at least one week. When dry, it is collected in bales, and can be carried away to be used as fodder. Baled hay can be stored either in the field or in barns for several months. Typically, hay contains at least 85% dry matter. CJ has proved to be a workable field crop in this respect, like any conventional source of hay, and edible by ruminants (s feeding experiment number 4).

2. Silage. The green crop is harvested, chopped, and while still wet it is compressed to exclude as much air as possible. Subsequently it is put in plastic bags, or covered in bunkers or silos, at anaerobic conditions during which time sugars are broken down to acids (notably lactic acid) the pH drops and the organic substance is preserved for various time periods. Once a package of silage is opened and exposed to air, deterioration ensues, and the remaining shelf life is then typically 1 week.

One option for this latter aspect is to ferment the fresh cut and chopped CJ in plastic bales either as a single component as is or as a component mixed with water, molasses, whey, or silage material as known in the art (such as wheat and/or maize and/or sorghum). Such CJ silages can be kept packed as long as 6 months. When unpacked such silages can be mixed with additional feed components to form total mixed rations (TMRs) forming a complete dietary system, or fed as is to productive ruminants.

Alternatively, freshly harvested CJ, or CJ based silages at about 22% to about 50% dry material (hereinafter DM) content, are packed in polyethylene bales a priori mixed with other components to form a TMR for productive ruminants, before it is packed anaerobically and ensiled in plastic bags. Such ensiled TMR has proven to provide fodder with a nutritive value similar to TMR which includes wheat silage as known in the art. Such TMR can include CJ at a level of about 10% to 100% of dietary roughage. As an example, in Israel, TMRs for lactating cows can contain about 30% to about 40% roughage feeds to contribute about 17% to about 21% roughage NDF (neutral detergent fiber, see below). If the ensilage is composed of less than 100% roughage, it can be made as a product in which CJ is mixed with other silage types, and/or additives such as molasses, wet soybean hull residues and whey and then mixed with regular TMR components (e.g., minerals, vitamins and protein sources). Such CJ-based TMRs can be further characterized by high nutritive value, long shelf-life outdoor of at least 6 months, and relatively high stability under aerobic exposure. NDF can be the fiber source essential for health and appropriate digestion of productive ruminants.

The following examples are provided to illustrate further and to facilitate the understanding of the present teachings and are not in any way intended to limit the invention.

Crop raising and early diagnostics regarding some characteristics of the raised crop. It was determined that good growth conditions for CJ as a commercial forage crop can include as follows: sowing rate—(15,000-20,000 g seeds per Ha); sowing season (November-January), (under Mediterranean climatic regime, the rainy season); pre-emergence treatments against weeds: Linurex (2000 cm³/Ha), Stomp (5500 cm³/Ha), and Alanex (4000 cm³/Ha); and post emergence treatment against weeds: Kerb-50 (2000 g/Ha). The names and rates of the herbicides as given are exemplary and do not constitute an endorsement of their use. Harvest time: at the beginning of flowering stage (April-July) for ensilage, direct ensilage or pre-wilting for hay production.

TABLE 1
A report of some parameters of the CJ crop derived
from early crop raising trials conducted as follows:
1. Crop raising trial 1: Site and year: Beit Dagan, Israel, 2008
2. Crop raising trial 2: Site and year: Beit Dagan, Israel, 2009
3. Crop raising trial 3: Site and year: Massuot Itzhak, Israel, 2009

| Parameter | trial 1 | trial 2 | trial 3 | SEM |
|---|---|---|---|---|
| Total annual rain, mm | 414 | 404 | 303 | |
| Crop yield, tons DM/Ha | 23.5^{a} | 24.7^{a} | 16.4^{b} | 0.09 |
| Plant leaf mass % | 18.5^{b} | 24.5^{a} | 22.7^{ab} | 1.6 |
| DM content, % | 39.0^{a} | 33.5^{b} | 39.8^{a} | 1.41 |
| Plant height, cm | 263 | 255 | 243 | 6.45 |
| NDF content, % | 54.9^{b} | 59.9^{a} | 54.6^{b} | 1.15 |
| In vitro DM digestibility, % | 58.0 | 57.4 | 57.3 | 0.9 |

SEM = standard error of the means

Experiments in which CJ was used solely or in combination as a feed preparation. The following experiments were made in order to determine the value of CJ based ensiled ruminant feed, and compare it with other sources of roughage as known in the art, notably wheat and sorghum silages.

The results of feed preparation experiment 1 are reported in Table 2.

TABLE 2
A report of some parameters of preparations of silages derived
from crop of CJ raised in the year 2009.

| | CJ fermented in combination, | | | | | |
|---|---|---|---|---|---|---|
| | in polyethylene bales | | | | | |
| Parameter | I | II | III | IV | V | SEM |
| pH of the silage | 4.37 | 4.05 | 4.20 | 4.07 | 3.97 | 0.20 |
| Silage DM (%) | 47.3^{a} | 38.2^{bc} | 35.5^{c} | 39.9^{bc} | 44.2^{c} | 1.80 |
| % loss of DM during | 9.80^{a} | 7.75^{ab} | 0^{c} | 3.25^{bc} | 2.00^{c} | 1.76 |
| ensilage | | | | | | |
| NDF content (%) | 62.2^{a} | 57.7^{b} | 57.3^{c} | 60.3^{ba} | 58.0^{a} | 0.97 |
| Protein content (%) | 6.88^{b} | 9.27^{a} | 9.06^{a} | 7.20^{b} | 7.91^{b} | 0.30 |
| IVDMD (%) | 56.1^{c} | 58.6^{b} | 57.4^{cb} | 59.2^{b} | 61.2^{a} | 0.65 |
| CO₂ produced in | 8.70^{b} | 1.50^{c} | 25.5^{a} | 1.70^{c} | 3.00^{c} | 0.72 |
| 7 days of exposure | | | | | | |
| to air (g/kg) | | | | | | |
| pH after 7 days of air | 4.91^{b} | 3.96^{b} | 5.15^{a} | 4.06^{b} | 3.91^{b} | 0.25 |
| exposure | | | | | | |

^{abcd}Values at the same line marked with different letters indicate significant difference.
NDF stands for neutral detergent fiber.
DM stands for dry matter.
IVDMD stands for in vitro dry matter digestibility.
Explanation of columns in the Table 2:
I—Fresh CJ alone
II—Silage of CJ + water + molasses, at the ratio of 3:1:1
III—silage of CJ + whey, at the ratio of 4:1
IV—Silage of CJ mixed with sorghum silage at the ratio of 1:1
V—Silage of CJ mixed with maize silage at the ratio of 1:1

The results of feed preparation experiment 2 are reported in Table 3.

TABLE 3
A report of some parameters of TMR containing a component
of CJ raised as crop in 2009 as compared with control TMRs.

| | TMRs fermented in | | | | | |
|---|---|---|---|---|---|---|
| | polyethylene bales | | | | | |
| Parameter | I | II | III | IV | V | SEM |
| pH of the ensiled packed | 4.37 | 4.33 | 4.36 | 4.17 | 4.12 | 0.07 |
| TMR | | | | | | |
| DM content of the ensiled | 53.3 | 58.3 | 56.9 | 56.0 | 55.2 | 0.70 |
| TMR (%) | | | | | | |
| Loss of DM during ensilage | 11.5^{a} | 0.35^{c} | 0.80^{c} | 1.50^{c} | 5.00^{b} | 0.60 |
| (%) | | | | | | |
| NDF in the ensiled TMR (%) | 38.1 | 39.5 | 41.9 | 38.8 | 39.9 | 0.87 |
| IVDMD digestibility (%) | 72.2 | 71.5 | 72.2 | 72.6 | 73.1 | 0.67 |
| CO₂ after 7 days of exposure | 0.90 | 1.60 | 2.10 | 0.20 | 1.00 | 0.80 |
| to air (g/kg) | | | | | | |
| pH after 7 days of exposure to | 4.35 | 4.32 | 4.34 | 4.14 | 4.14 | 0.11 |
| air | | | | | | |

I—Control - Commercial TMR of the prior art based on wheat and corn silages at the ratio of 1:1 as the source of roughage in the TMR.
II—Fresh cut CJ as a sole roughage in the ensiled TMR.
III—Fresh cut CJ mixed with wheat silage at the ratio of 1:1 as the source of roughage in the ensiled TMR.
IV—Fresh cut CJ mixed with sorghum silage at the ratio of 1:2 as the source of roughage in the TMR.
V—Control - wheat silage mixed with sorghum silage at the ratio of 1:2 as the source of roughage in the TMR.

Animal Feeding Experiments.

Feeding experiment 1. Table 4. A report of dry matter digestibility by sheep of silages providing TMR containing a component of CJ raised as crop in 2009, as described above, reference is made to Table 3.

| | TMRs fermented in | | | | | |
|---|---|---|---|---|---|---|
| | polyethylene bales | | | | | |
| Parameter | I | II | III | IV | V | SEM |
| DM digestibility (%, | 71.4 | 67.6 | 70.2 | 67.4 | 71.3 | 0.95 |
| by sheep) | | | | | | |

I—Control - Commercial TMR of the prior art based on wheat and corn silages at the ratio of 1:1 as the source of roughage in the TMR.
II—Fresh cut CJ as a sole roughage in the ensiled TMR.
III—Fresh cut CJ mixed with wheat silage at the ratio of 1:1 as the source of roughage in the ensiled TMR.
IV—Fresh cut CJ mixed with sorghum silage at the ratio of 1:2 as the source of roughage in the TMR.
V—Control - wheat silage mixed with sorghum silage at the ratio of 1:2 as the source of roughage in the TMR.

Feeding Experiment 2.

TABLE 5
A report of some feed consumption and milk production parameters
of cows fed with two different TMRs, one containing CJ
silage (TMR IV in Table 4) and the other, a control TMR
containing wheat silage (TMR V in Table 4).

| | CJ as sole | Control, wheat | |
|---|---|---|---|
| | roughage | as sole roughage | |
| Parameter | in the TMR | in the TMR | SEM |
| DM consumption (kg/cow/day) | 21.6 | 22.0 | 0.31 |
| DM digestibility by cows (%) | 67.9 | 69.0 | 0.39 |
| Milk production (kg/cow/day) | 35.5^{b} | 36.5^{a} | 0.18 |
| Milk fat (%) | 3.21 | 3.21 | 0.05 |
| Milk protein (%) | 2.74 | 2.78 | 0.03 |
| Milk lactose (%) | 4.78 | 4.79 | 0.01 |
| Economically corrected milk | 30.4^{b} | 31.6^{a} | 0.19 |
| yield (kg/cow/day) | | | |

^{ab}Values at the same line marked with different letters indicate significant difference at P < 0.05

Feeding experiment 3. In another feeding experiment, CJ was raised as a crop grown on an area of 10 Ha in Yoqneam, Israel, with no supplementary irrigation. A potential yield of 16 tons DM per Ha was obtained. In some locations in the plot lodging of the stems occurred, in which case a potential yield of 12 tons DM per Ha was obtained.

TABLE 6
A report of some feed consumption and milk production
parameters of cows fed with two different ensiled TMRs,
one containing fresh CJ as the sole roughage and the other,
a control ensiled TMR containing wheat silage.

| | CJ as sole | Control, wheat | |
|---|---|---|---|
| | roughage in | as sole roughage | |
| Parameter | the TMR | in the TMR | SEM |
| DM consumption (kg/cow/day) | 21.2 | 21.5 | 0.28 |
| Milk production (kg/cow/day) | 35.8 | 35.1 | 0.32 |
| Milk fat (%) | 3.51 | 3.50 | 0.02 |
| Milk protein (%) | 2.74^{a} | 2.58^{b} | 0.01 |
| Economically corrected milk | 31.9^{a} | 30.3^{b} | 0.03 |
| yield (kg/cow/day) | | | |
| Resting time (minutes) | 498 | 467 | 12.2 |
| DM digestibility (%) | 58.9 | 60.1 | 0.62 |
| NDF digestibility (%) | 38.3 | 36.9 | 0.56 |

^{ab}Values at the same line marked with different letters indicate significant difference P < 0.05

The results show some advantage to the CJ with respect to yield of economically corrected milk.

Feeding experiment 4. In this experiment, CJ raised in a commercial field was harvested at the stage of early flowering, and the cut crop was wilted for a week in the field. Subsequently, the wilted hay was collected and packed by a compress-chopper, in bales weighing about half a ton each.

A control group of animals housed in a cowshed included a 100 cows was fed using a prior art TMR containing 15% of the dry matter derived from vetch and wheat hay for a period of 30 days. The experimental group, containing also 100 cows with similar initial performance, was fed a similar TMR containing 15% of the dry matter CJ hay, i.e. replacing the entirety of the hay of the prior art. The results show that the experimental group delivered 38.9 kg milk per cow per day and the control group delivered 39.0 kg milk per cow per day, not a significant difference. Also the total milk solids of each group were not significantly different.

With respect to the inclusion of harvested CJ in a TMR, the proportions of harvested CJ vary depending on the ruminant to be fed and/or its biological status, for example, whether lactating or in a dry period. The following table summarizes such proportions of various productive ruminants in the U.S. and Europe.

| | Minimal level | Maximal level | Recommended |
|---|---|---|---|
| | of CJ (wgt % | of CJ (wgt % | forage level (wgt % |
| Animal | of TMR DM) | of TMR DM) | of TMR DM) |
| Lactating cows | 5 | 30-50 | 30-50 |
| Lactating ewes | | 30-50 | 30-50 |
| and goats | | | |
| Growing | 5 | 15-30 | 15-30 |
| bulls* | | | |
| Growing | 5 | 70-85 | 70-85 |
| heifers | | | |
| Growing lambs | 5 | 5-30 | 5-30 |
| and kids* | | | |
| Dry cows, | 5 | 70-85 | 70-85 |
| sheep and | | | |
| goats | | | |

*Different TMRs can be used in different geographical regions for growing bulls, lambs and kids. In Israel, for lambs and kids, only 5% of TMR are forages (roughage) while in growing bulls about 15%-25% are forages. In contrast, in Europe, forages can be included up to 30% of TMR for these animals.

The nutritive value of CJ is similar to that of wheat: TDN (total digestible nutrients) is about 58%; ME (metabolizable energy) is 2.09 Mcal/kg; and NE_{L} (net energy for lactation) is 1.28 Mcal/kg.

To summarize the characteristics of CJ, as demonstrated in the experiments above, in view of the CJ species being a potential feed crop for ruminants, and successful replacer of wheat silage or hay and leguminous forages, the following stand out: (1) based on the data in Table 1, CJ has a higher DM production per hectare than wheat, as known in Israel, with new varieties of CJ developed, outperforming the current varieties in this respect; (2) the nutritive value of CJ as roughage for dairy cows equals that of wheat silage (referring to Tables 3-5 and Experiment 4 above); (3) the practice according to which fresh cut CJ is mixed with other components, bailed and ensilaged in plastic offers a specific advantage in that the entire silage, whether TMR or not, is easily transportable and made ready to use conveniently.

Throughout the application, where compositions are described as having, including, or comprising specific components, or where processes are described as having, including, or comprising specific process steps, it is contemplated that compositions of the present teachings also consist essentially of, or consist of, the recited components, and that the processes of the present teachings also consist essentially of, or consist of, the recited process steps.

In the application, where an element or component is said to be included in and/or selected from a list of recited elements or components, it should be understood that the element or component can be any one of the recited elements or components, or the element or component can be selected from a group consisting of two or more of the recited elements or components.

Further, it should be understood that elements and/or features of a composition, an apparatus, or a method described herein can be combined in a variety of ways without departing from the spirit and scope of the present teachings, whether explicit or implicit herein. For example, where reference is made to a particular structure, that structure can be used in various embodiments of apparatus of the present teachings and/or in methods of the present teachings, unless otherwise understood from the context. In other words, within this application, embodiments have been described and depicted in a way that enables a clear and concise application to be written and drawn, but it is intended and will be appreciated that embodiments may be variously combined or separated without parting from the present teachings and invention(s). For example, it will be appreciated that all features described and depicted herein can be applicable to all aspects of the invention(s) described and depicted herein.

It should be understood that the expression “at least one of” includes individually each of the recited objects after the expression and the various combinations of two or more of the recited objects unless otherwise understood from the context and use.

The use of the term “include,” “includes,” “including,” “have,” “has,” “having,” “contain,” “contains,” or “containing,” including grammatical equivalents thereof, should be understood generally as open-ended and non-limiting, for example, not excluding additional unrecited elements or steps, unless otherwise specifically stated or understood from the context.

The use of the singular herein, for example, “a,” “an,” and “the,” includes the plural (and vice versa) unless specifically stated otherwise.

Where the use of the term “about” is before a quantitative value, the present teachings also include the specific quantitative value itself, unless specifically stated otherwise. As used herein, the term “about” refers to a ±10% variation from the nominal value unless otherwise indicated or inferred.

Where a percentage is provided with respect to a component of a TMR or with respect to the TMR, the percentage should be understood to be a percentage based on weight, unless otherwise understood from the context. For example, 85% of the dry matter of the TMR is harvested CJ means that 85% by weight of the TMR is harvested CJ.

It should be understood that the order of steps or order for performing certain actions is immaterial so long as the present teachings remain operable. Moreover, two or more steps or actions may be conducted simultaneously.

At various places in the present specification, values are disclosed in groups or in ranges. It is specifically intended that the description include each and every individual subcombination of the members of such groups and ranges and any combination of the various endpoints of such groups or ranges. For example, an integer in the range of 0 to 40 is specifically intended to individually disclose 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40, and an integer in the range of 1 to 20 is specifically intended to individually disclose 1, 2, 3, 4, 5, 6, 7, 8, 9, 10, 11, 12, 13, 14, 15, 16, 17, 18, 19, and 20.

The use of any and all examples, or exemplary language herein, for example, “such as,” “including,” or “for example,” is intended merely to illustrate better the present teachings and does not pose a limitation on the scope of the invention unless claimed. No language in the specification should be construed as indicating any non-claimed element as essential to the practice of the present teachings.

The present teachings encompass embodiments in other specific forms without departing from the spirit or essential characteristics thereof. The foregoing embodiments are therefore to be considered in all respects illustrative rather than limiting on the present teachings described herein. Scope of the present invention is thus indicated by the appended claims rather than by the foregoing description, and all changes that come within the meaning and range of equivalency of the claims are intended to be embraced therein.

What is claimed is:

1. A total mixed ration (TMR) for heifers and/or dry cows and/or dry sheep, the TMR comprising:
harvested Cephalaria joppensis; and
an additional feed component,
wherein about 5% by weight to about 85% by weight of the dry matter of the TMR is harvested Cephalaria joppensis.

2. The TMR of claim 1 wherein the harvested Cephalaria joppensis comprises at least one of ensiled Cephalaria joppensis and dried Cephalaria joppensis.

3. The TMR of claim 1, wherein the additional feed component comprises at least one of a mineral, a vitamin, and a protein source.

4. The TMR of claim 1, wherein the TMR comprises between about 70% by weight to about 85% by weight roughage.

5. The TMR of claim 4, wherein the TMR comprises at least one of wheat silage, maize silage, sorghum silage, legume silage, grass silage, wheat hay, maize hay, sorghum hay, grass hay, and legume hay.

6. A total mixed ration (TMR) for lactating ruminants, the TMR comprising:
harvested Cephalaria joppensis; and
an additional feed component,
wherein about 5% by weight to about 50% by weight of the dry matter of the TMR is harvested Cephalaria joppensis.

7. The TMR of claim 6 wherein the harvested Cephalaria joppensis comprises at least one of ensiled Cephalaria joppensis and dried Cephalaria joppensis.

8. The TMR of claim 6, wherein the additional feed component comprises at least one of a grain, a mineral, a vitamin, and a protein source.

9. The TMR of claim 6, wherein the TMR comprises between about 30% by weight to about 50% by weight roughage.

10. The TMR of claim 9, wherein the TMR comprises at least one of wheat silage, maize silage, sorghum silage, legume silage, grass silage, wheat hay, maize hay, sorghum hay, grass hay, and legume hay.

11. A total mixed ration (TMR) for lambs, kids or bulls, the TMR comprising:
harvested Cephalaria joppensis; and
an additional feed component,
wherein about 5% by weight to about 30% by weight of the dry matter of the TMR is harvested Cephalaria joppensis.

12. The TMR of claim 11 wherein the harvested Cephalaria joppensis comprises at least one of ensiled Cephalaria joppensis and dried Cephalaria joppensis.

13. The TMR of claim 11, wherein the additional feed component comprises at least one of a grain, a mineral, a vitamin, and a protein source.

14. The TMR of claim 11, wherein the TMR comprises between about 30% by weight to about 50% by weight roughage.

15. The TMR of claim 11, wherein the TMR comprises at least one of wheat silage, maize silage, sorghum silage, legume silage, grass silage, wheat hay, maize hay, sorghum hay, grass hay, and legume hay.
